(19) United States
(12) Patent Application Publication
(10) Pub. No.: US 2003/0220808 A1
(43) Pub. Date: Nov. 27, 2003

(54) Method for recruiting personnel for businesses and organizations

(76) Inventor: Bruce A. Ballard, Ocala, FL (US)

Correspondence Address: Edward M. Livingston, Esq., 628 Ellen Dr., P.O. Box 1599, Winter Park, FL, 32790, US

(21) Appl. No.: 10/357,116

(22) Filed: Jan. 31, 2003

Related U.S. Application Data
(60) Provisional application No. 60/354,191, filed on Feb. 4, 2002.

(51) Int. Cl. G06F 17/60

(52) U.S. Cl. 705/1

(57) ABSTRACT

A business method involving the partnering of recruiters and organizations for the hiring of personnel for organizations that are members of a network practicing the business method. The method involves the establishment of a true cost of hiring, providing immediate cost reduction of hiring by arriving at fixed cost for hiring, sharing profits and paying referral bonuses as incentives. The method creates market share, loyalty and longevity between the recruiting company and a business and increases collection rates for fees to the recruiting company. The method is also beneficial to the employer by reducing the cost to a business of hiring new employees and decreasing employee turnover. The network referrals give an organization a unique ability to fully underwrite the human resource department budget, help underwrite employee hiring cost, increase medical and employee-related benefits and expansion through these network referrals, literally turning the current human resource department from a profit-draining center into a profit-making center and providing continued growth and market share for the recruiting company.

### CROSS-REFERENCE TO RELATED APPLICATION

This is application claims the benefit of U.S. Provisional Application No. 60/354,191, filed Feb. 4, 2002.

### BACKGROUND OF THE INVENTION

This invention relates to a business method for recruiting permanent, temporary, evaluation, and contract personnel, for business and other organizations.

Most employer companies and business owners believe the most valuable asset they have is their employees. However, finding and retaining good employees is such a time-consuming and expensive process. Although most large corporations have an extensive in-house, profit draining human resource center, they are unable to meet the demand for new employees. Most large corporations turn to staffing companies and recruiters, often referred to as “headhunters” who specialize in finding the right employee. The need to outsource these placements strains an already dwindling corporate profit structure. Part of a Chief Executive Officer's (CEO's) value to his/her corporation is how well he or she manage this cost to enhance corporate profits.

Recruiting and staffing companies experience problems that often hinder their ability to serve the companies that hire them to recruit employees. One problem experienced by recruiting companies is that there is a very high turnover by the very businesses that hire them. Such turnover often makes it difficult for the recruiting companies to learn the needs of their clients, thereby adversely impacting their ability to find the right employees for that company.

Another problem experienced by recruiting companies involves getting paid for the services they provide. Recruiters and staffing companies have difficulty with collecting fees for their work as some employing companies fail to pay them, especially if an employee later leaves a company.

Another problem is that recruiters and staffing companies find themselves working directly with the existing ineffective, human resource department, in lieu of the CEO or owner of a corporation who are profit conscience. Most cost saving ideas are viewed as threatening and never make it past the Human resource department. The recruiter and or staffing company is often replaced (client turn over) by a competitor at the whim of the human resource department. There is no client longevity or loyalty to the staffing company.

On the other side of the equation, employers also encounter problems with current human resource recruiting methods. Employing companies and organizations expend more time and money then needed as a result of bad recruiting and hiring decisions. The use of recruiters and staffing companies as well as fully funding an internal human resource department, and funding increasing medical and employee related benefits, adds a tremendous extra cost burden. This adds even greater pressure to the dwindling corporate profit, margin, which in return has a negative impact on the CEO's value to his or her corporation.

Thus, the goal of the present invention is to solve the above problems associated with recruiting permanent, temporary, evaluation, and contract personnel for companies and organizations, to cut corporate cost by establishing a single resource network, fix cost for cost control, thereby enhancing corporate profits, to create a greater recruiting resource pool (better employees) thereby reducing employee turnover, to eliminate duplicate positions in the profit draining human resource centers, to create corporate incentives for long term client loyalty, timely payments to the recruiting and staffing company and to use network referrals giving the client corporation the ability to fully underwrite the human resource department budget. Underwriting hiring costs and increased medical and employee related benefits or corporate expansion through these network referrals, literally turns the human resource department from a profit-draining center into a profit-making center through these referrals for continued growth and market share for the staffing company. Working directly with the CEO, business owner or key human resource personnel on a unique employee cost approach to cut hiring cost and enhance corporate profits increases the CEO's and/or key human resource personnel's value to his/her corporation, thereby creating client longevity.

The prior art includes many patented business methods and systems for various purposes, even some for facilitating employee recruiting. However, none are like the present invention. For instance, the following U.S. Patents involve pertinent business methods:

| U.S. Pat. No. | Inventor | Issue Date |
|---|---|---|
| 6,308,162 | Ouimet, et al. | Oct. 23, 2001 |
| 6,101,484 | Halbert, et al. | Aug. 08, 2000 |
| 5,991,376 | Hennessy, et al. | Nov. 23, 1999 |
| 6,292,785 | McEvoy, et al. | Sep. 18, 2001 |
| 5,001,630 | Wiltfong | Mar. 19, 1991 |
| 5,249,120 | Foley | Sep. 28, 1993 |
| 5,799,286 | Morgan, et al. | Aug. 25, 1998 |
| 6,049,778 | Walker, et al. | Apr. 11, 2000 |
| 5,884,270 | Walker, et al. | Mar. 16, 1999 |

The Ouimet, et al. patent discloses a computerized method for optimizing an enterprise planning model in which increasing market share is a goal.

The Halbert, et al. patent discloses a system and process for modifying a price curb and approaching market equilibrium in an online buying co-op.

The Hennessy, et al. patent discloses a telephone subscriber reward program by a carrier to reward customer loyalty.

The McEvoy, et al. patent discloses a business system and method of compiling mailing lists by using magazine subscriber redemption coupons.

The Wiltfong patent teaches a business system for providing client histories, procedures and so forth for an office or business.

The Foley patent discloses an automated manufacturing cost estimating system with indirect cost allocation.

The Morgan, et al. patent teaches an automated management system which can determine cost for a particular activity associated with the people, facilities and equipment used therein.

The Walker, et al. '778 patent teaches a computerized method for administering a program for rewarding early purchases of a successful product.

Finally, the Walker, et al. '270 patent teaches a method of facilitating employee recruiting in which a bonus is part of the plan.

None of the above patents disclose a method for recruiting employees that is as sophisticated and effective as that taught by present invention.

### SUMMARY OF THE INVENTION

The objects of the present invention are to provide a business method for recruiting permanent, temporary, evaluation, contract personnel for businesses and organizations that:

reduces corporate cost by establishing a single resource network, thereby enhancing corporate profits;

creates a greater recruiting resource pool thereby reducing employee turnover;

eliminates costly duplicated positions in the profit draining human resource centers;

creates performance incentives for long term client loyalty, timely payments to the recruiting and staffing company, and network referrals for continued growth and market share;

works directly with the CEO or business owner on a unique employee cost approach to cut hiring cost and enhance corporate profits, thereby increasing the CEO's value to his/her corporation, thereby creating client longevity; and

cuts hiring cost and enhance corporate profits.

The present invention accomplishes the above and other objects by providing a business method for recruiting personnel which involves working with the company to establish a true cost of hiring, providing immediate cost reduction, hiring at a fixed cost, sharing the profits and providing bonuses to companies which work with the recruiter. The end result of the present invention is the establishment of a network of employers that further increases the employee recruiting efficiency of the entire network.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawing in which:

FIG. 1 is a block diagram illustrating the steps involved in the method of the present invention for recruiting employees.

### DESCRIPTION OF THE PREFERRED EMBODIMENT

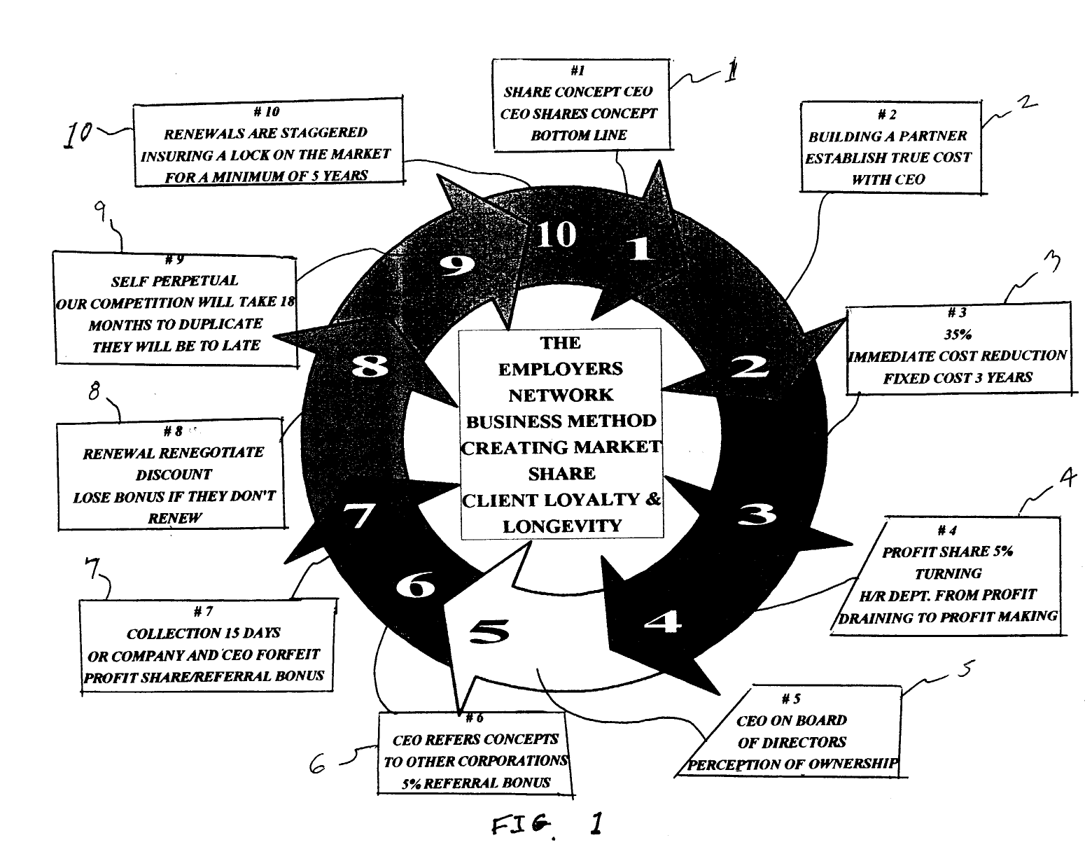

Referring to FIG. 1, the steps of the business method of the present invention are illustrated. Essentially, the present method can be reduced to ten steps.

Step 1 involves working directly with the Chief Executive Officer (CEO) or the business owner. This step involves a meeting with the CEO or business owner in which the concept of the business method is shared on a confidential basis. The unique appointment is often made by network members for the recruiting or staffing company.

Step 2 involves establishing a true (hiring) cost with the CEO or business owner for hiring new employees. In this step each position is examined. The total pay and benefits are multiplied by the percentage of time invested in training the new employee over the first year after hiring to determine the hard costs of hiring each employee for each position. The total of the hard costs is then added to the total of all costs for promotion and advertising directed toward hiring an employee, including recruiting costs, advertising, trade shows, job fairs, seminars and staffing. The latter subtotal is then added to the cost of office space utilized and other miscellaneous costs, such as drug and criminal checks, to arrive at an overall total figure. Once the total cost is ascertained, then a partnership is established with the employer to reduce those costs, which constitutes Step 3.

In Step 3 an agreement is entered into for an immediate cost reduction in the total hiring cost of a predetermined percentage, preferably thirty-five percent (35%) over a three year period.

Step 4 involves the payment by a recruiter to the business of a performance sharing bonus equal to a predetermined percentage of all money earned by the recruiting company in fees related to the hiring of all core employees, the predetermined percentage preferably being five percent (5%). The payment of this bonus is made at the end of each year. The latter sharing of fees turns the human resources department of the business from a typical profit-draining center to a profit-making center.

In Step 5 the CEO of the company has increased his or her value to the company or organization by turning a human resources function of the company into a profit maker. The CEO becomes more valuable to his/her corporation by becoming an advisory board member for the employee resource network. He essentially assists in the further development of the employee resource network to lower the overall corporate cost, thus giving the perception of partial ownership of the recruiter and staffing company. Also, as more and more employees join the network involving this method, each business has a better pool of prospective employees.

Step 6 provides for the payment of a referral bonus of a predetermined percentage of the fees associated with core hiring on any corporation who was referred to by any member of the network, the predetermined percentage preferably being five percent (5%). The referral bonus is paid annually to the CEO, owner or the company on each anniversary date. CEO and/or human resource personnel refer other corporations into the network. The referral bonus helps to underwrite human resource department cost, employee benefits and/or plant expansion, hereby, turning the human resource department from a profit-draining center into a profit-making center. Referrals are paid on an annual basis creating corporate incentive to renew the arrangement, hereby creating client loyalty and longevity for the staffing company.

Step 7 of the business method involves instituting a requirement that all collections of payments on fees related to a recruited employee be paid within fifteen days of a due dates; otherwise, performance-sharing bonus and referral bonus are forfeited. The potential forfeit of bonuses insures the timely payment and collection of all fees due the recruiting company.

Step 8 involves the renewal of the partnership agreement with the business. At this time the discount or hiring cost reduction which was agreed to within the first three years of working with the employer can be renegotiated. Again, the incentive for the CEO or business owner to renew the agreement is that non-renewal will result in greater cost and reduced profits. The CEO, business owner or company has incentive to renew, as he/she will forfeit any referral bonuses that come after the renewal date if he/she/it is not a network member. As the member corporations or businesses involved in the network will be joining over different periods of time, the renewals will be staggered, therein insuring a lock on the market share for a minimum of five years. The staggering of renewals are incentive for the company to renew the arrangement.

Step 9 involves self-perpetuating the network of employers utilized in the business method by renewing the agreement. The agreement with each business or employer is exclusive as to the recruiter which makes it difficult for competitors to take the business of a recruiter who is a member of the network employing this recruiting method. Thus, the network business method is self perpetual as marketing the method is accomplished through CEO/owner and human resource department referrals.

In Step 10 the renewals are staggered, thereby increasing market share for the staffing company for a minimum of 5 years, hereby creating market dominance for 10 years.

Thus, as described above, the business method of recruiting employees disclosed herein aids recruiting companies and helps employing companies or organizations by reducing the overall cost associated with hiring, increasing loyalty of a business to the recruiting company, benefit the business by reducing costs of hiring employees and reducing employee turnover.

Having thus described my invention, I claim:

1. A method for recruiting personnel for an organization by a recruiter, said method comprising the steps of:
entering into an exclusive agreement for an initial period between the recruiter and organization to recruit personnel for at least one position in the organization;
establishing a hiring cost for the at least one position in an organization to arrive at a total hiring cost;
entering into an agreement with the organization to reduce the total hiring cost by a predetermined percentage over a predetermined time period;
paying a performance sharing bonus by the recruiter to the organization based on all fees earned by the recruiter related to hiring of personnel for the at least one position in the organization over the predetermined time period;
paying a referral bonus of a predetermined percentage of fees associated with hiring personnel for any organization referred to the recruiter by the organization;
imposing a requirement that all payment of fees to the recruiter for recruiting personnel for the organization are made in a predetermined time period and imposing a penalty for untimely payment; and
entering into a renewal of the agreement with the organization at the end of the predetermined period.

2. The method for recruiting personnel of claim 1 wherein the step of establishing the hiring cost comprises:
multiplying the total pay and benefits for the at least one position by a percentage of time invested in training a person for the at least one position, a first year after hiring to determine a hard cost of hiring each person for the at least one position; and
totaling all hard costs of each person for the at least one position and adding to the resulting total all costs for promotion and advertising directed toward hiring a person for the at least one position.

3. The method for recruiting personnel of claim 1 wherein:
the predetermined percentage is thirty-five percent.

4. The method for recruiting personnel of claim 1 wherein:
the predetermined time period is three years.

5. The method for recruiting personnel of claim 1 wherein:
the performance sharing bonus is five percent.

6. The method for recruiting personnel of claim 1 wherein:
the referral bonus is five percent.

7. The method for recruiting personnel of claim 1 wherein:
the predetermined time period for the payment of recruiting fees is within fifteen days of a due date.

8. The method for recruiting personnel of claim 1 further comprising:
repeating all of the steps of the method with a plurality of organizations.

9. The method for recruiting personnel of claim 2 further comprising:
repeating all of the steps of the method with a plurality of organizations.

10. The method for recruiting personnel of claim 8 comprises:
staggering renewals of the agreements with the plurality of organizations.

11. The method for recruiting personnel of claim 9 comprises:
staggering renewals of the agreements with the plurality of organizations.
